(19) United States
(12) Patent Application Publication
(10) Pub. No.: US 2026/0225114 A1
(43) Pub. Date: Aug. 6, 2026

(54) Cell Centrifuge, Method, Controller, and Medium

(71) Applicant: SHENZHEN CELLBRI BIO-INNOVATION TECHNOLOGY CO., LTD., Shenzhen, Guangdong (CN)

(72) Inventors: Xiaoliang Guo, Shenzhen, Guangdong (CN); Yuanfang Shang, Shenzhen, Guangdong (CN); Xiaosong Li, Shenzhen, Guangdong (CN); Jieying Chen, Shenzhen, Guangdong (CN)

(21) Appl. No.: 19/653,252

(22) Filed: Apr. 21, 2026

Related U.S. Application Data
(63) Continuation of application No. PCT/CN2023/140510, filed on Dec. 21, 2023.

(30) Foreign Application Priority Data
Sep. 22, 2023 (CN) 202311240847.2

(51) Int. Cl. B04B 11/02; B04B 7/12; B04B 13/00

(52) U.S. Cl. CPC B04B 11/02; B04B 7/12; B04B 13/00

(57) ABSTRACT

The present application provides a cell centrifuge, a method, a controller, and a medium. The cell centrifuge includes a cup body provided with a centrifugation space and a first passage. The cup body has a rotation axis and is rotatable about the rotation axis. The first passage includes a delivery passage provided at the top of the cup body, and a curved passage provided on a side wall of the cup body. Two ends of the curved passage are respectively provided with a first opening and a second opening. The first opening is provided on an inner side wall of the cup body. The curved passage communicates with the centrifugation space through the first opening and communicates with the delivery passage through the second opening. The curved passage also includes at least one bent passage located outside the inner side wall of the cup body.

### CROSS REFERENCE TO RELATED APPLICATIONS

The present application is a Continuation Application of PCT Application No. PCT/CN2023/140510 filed on December 21, 2023, which claims priority to the Chinese patent application filed with the China National Intellectual Property Administration on September 22, 2023, with the application number 202311240847.2 and entitled "Cell Centrifuge, Method, Controller, and Medium", the entire contents of which are incorporated herein by reference.

### TECHNICAL FIELD

The present application relates to the technical field of cell centrifugation, and more particularly to a cell centrifuge, a method, a controller, and a medium.

### BACKGROUND

Currently, when performing cell separation, cell centrifugation operations are often required using a cylindrical centrifugation device, which utilizes the principle that centrifugal force increases along the radial direction to separate different components in a cell fluid. However, the inventor has recognized that in the process of performing centrifugation operations on target cells using existing centrifugation devices, the extraction of substances such as impurities and culture media other than the target cells generally suffers from the problem of a large residual volume. This leads to a large final minimum concentrated volume, which fails to meet the requirements of pharmaceutical companies. Consequently, different devices must be connected for multiple centrifugation operations to satisfy these requirements, resulting in low efficiency and high costs. At the same time, existing centrifugation devices also suffer from problems such as slow processing speed and long processing time, which similarly lead to low processing efficiency and increased costs.

### SUMMARY

Addressing technical problems such as large residual volume and low efficiency during centrifugation operations of cell centrifuges in the prior art, the present application provides a cell centrifuge, a method, a controller, and a medium.

In view of the above technical problems, embodiments of the present application provide a cell centrifuge including a cup body provided with a centrifugation space and a first passage. The cup body has a rotation axis and is rotatable about the rotation axis. The first passage includes a delivery passage provided at the top of the cup body, and a curved passage provided on a side wall of the cup body. Two ends of the curved passage are respectively provided with a first opening and a second opening. The first opening is provided on an inner side wall of the cup body. The curved passage communicates with the centrifugation space through the first opening and communicates with the delivery passage through the second opening. The curved passage also includes at least one bent passage located outside the inner side wall of the cup body.

A cell centrifugation method is executed by the cell centrifuge. The cell centrifugation method includes:

controlling a first preset dose of a separation liquid to flow into the centrifugation space in the cup body of the cell centrifuge;

after controlling the cup body to rotate about the rotation axis at a first preset speed, controlling a second preset dose of a sample liquid to flow into the centrifugation space at a preset flow rate;

controlling the cup body to rotate at a second preset speed for a first preset duration to perform a centrifugation operation on a liquid in the centrifugation space in the cup body, so that target cells in the sample liquid are closely attached to the inner side wall of the cup body;

after the centrifugation operation, discharging the liquid other than the target cells from the centrifugation space sequentially through the first opening of the first passage, the curved passage, and the delivery passage.

Optionally, after the controlling a second preset dose of a sample liquid to flow into the centrifugation space at a preset flow rate, the method further includes:

controlling a third preset dose of the separation liquid to flow into the centrifugation space.

Optionally, the cup body further includes a second passage provided at the bottom of the cup body and communicating with the centrifugation space. After the discharging the liquid other than the target cells from the centrifugation space sequentially through the first opening, the curved passage, and the delivery passage, the method further includes:

upon detecting that the liquid discharged from the first passage has been exhausted, controlling a target base liquid to flow into the centrifugation space;

controlling the cup body to rotate at a third preset speed for a second preset duration to uniformly mix the target cells in the centrifugation space with the target base liquid to obtain a mixed liquid;

discharging the mixed liquid in the centrifugation space through the second passage into a preset storage container.

A controller includes a processor and a memory. The memory stores an executable program. The processor is used to execute the executable program to implement the cell centrifugation method.

One or more computer-readable storage media store a computer-readable instruction. When the computer-readable instruction is executed by one or more processors, the one or more processors implement the cell centrifugation method.

The cell centrifuge provided by the present application includes a cup body provided with a centrifugation space and a first passage. The cup body has a rotation axis and is rotatable about the rotation axis. The first passage includes a delivery passage provided at the top of the cup body and a curved passage provided on a side wall of the cup body. Two ends of the curved passage are respectively provided with a first opening and a second opening. The first opening is provided on an inner side wall of the cup body. The curved passage communicates with the centrifugation space through the first opening and communicates with the delivery passage through the second opening. The curved passage also includes at least one bent passage located outside the inner side wall of the cup body. Through the design of the curved passage and the delivery passage on the cup body, the present application can maximize the extraction of other liquids except for the target cells attached to the inner side wall of the cup body while avoiding the extraction of the target cells as much as possible, thereby minimizing liquid residue, reducing the minimum concentrated volume, lowering costs, and improving cell centrifugation efficiency.

Details of one or more embodiments of the present application are set forth in the following drawings and description. Other features and advantages of the present application will become apparent from the specification, drawings, and claims.

### DESCRIPTION OF THE DRAWINGS

The present application is further described below in conjunction with the accompanying drawings and embodiments.

FIG. 1 is a structural schematic diagram of a cell centrifuge provided by an embodiment of the present application.

FIG. 2 is a structural schematic diagram of a cup cap provided by another embodiment of the present application.

FIG. 3 is a structural schematic diagram of a liquid pushing plate provided by an embodiment of the present application.

FIG. 4 is a flowchart of a cell centrifugation method provided by an embodiment of the present application.

FIG. 5 is a flowchart of a cell centrifugation method provided by another embodiment of the present application.

FIG. 6 is a flowchart of a cell centrifugation method provided by yet another embodiment of the present application.

### Reference signs in the specification are as follows:

100. Cup body; 110. Centrifugation space; 120. First passage; 121. Delivery passage; 122. Curved passage; 1221. First opening; 1222. Second opening; 1223. Bent passage; 130. Recess; 140. Delivery slot; 150. Winding slot; 160. Second passage; 161. Third opening; 171. Straight wall segment; 172. Slope segment; 180. Cup body shell; 190. Cup cap; 191. First access passage; 192. Second access passage; 200. Liquid pushing plate; 210. Pushing body; 220. Flow guiding portion; 211. Connecting portion; 212. Pushing portion.

### DETAILED DESCRIPTION

To make the technical problems to be solved, technical solutions, and beneficial effects of the present application clearer, the present application is further described in detail below in conjunction with the accompanying drawings and embodiments. It should be understood that the specific embodiments described here are only used to explain the present application and are not intended to limit the present application.

It should be understood that the orientations or positional relationships indicated by terms such as "upper," "lower," "left," "right," "front," "rear," and "middle" are based on the orientations or positional relationships shown in the drawings. These terms are only for the convenience of describing the present application and simplifying the description, rather than indicating or implying that the device or element referred to must have a specific orientation or be constructed and operated in a specific orientation. Therefore, they cannot be understood as limitations on the present application.

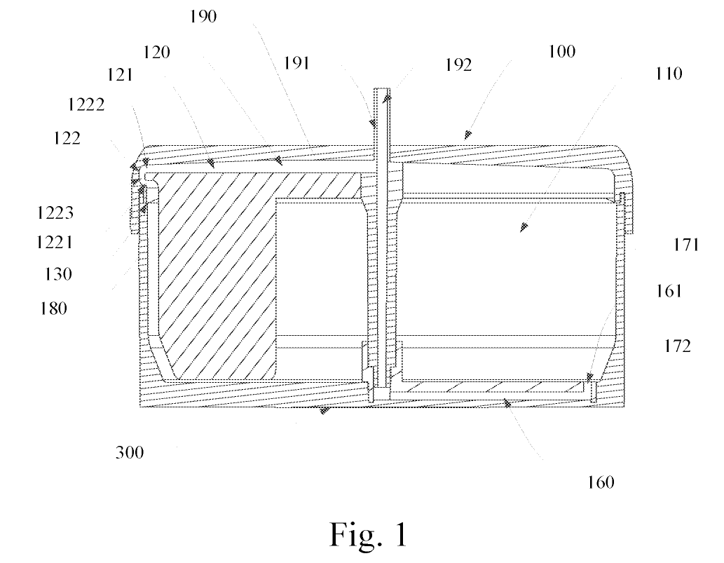

As shown in FIGS. 1 to 3, an embodiment of the present application provides a cell centrifuge including a cup body 100 provided with a centrifugation space 110 and a first passage 120. The cup body 100 has a rotation axis, and the cup body 100 is rotatable about the rotation axis. The first passage 120 includes a delivery passage 121 provided at the top of the cup body 100, and a curved passage 122 provided on a side wall of the cup body 100. Two ends of the curved passage 122 are respectively provided with a first opening 1221 and a second opening 1222. The first opening 1221 is provided on the inner side wall of the cup body 100. The curved passage 122 communicates with the centrifugation space 110 through the first opening 1221, and the curved passage 122 communicates with the delivery passage 121 through the second opening 1222. The curved passage 122 also includes at least one bent passage 1223 located outside the inner side wall of the cup body 100. Understandably, in the embodiment shown in FIG. 1, the second opening 1222 is located at a position substantially flush with the first opening 1221 (i.e., the inner side wall of the cup body 100). However, in other embodiments, the second opening 1222 can also be located on the outside or inside of the inner side wall of the cup body 100 without being limited thereto. The cup body 100 can be a cylinder or a cylindrical-like body.

Further, the cell centrifuge also includes a rotary drive mechanism (not shown) connected to the cup body 100. The cup body 100 rotates about the rotation axis under the drive of the rotary drive mechanism to centrifuge liquid contained in the centrifugation space.

In one embodiment, a first distance between an inflection point of the bent passage 1223 and the rotation axis is greater than a second distance between the inner side wall of the cup body 100 and the rotation axis. The curved passage 122 may consist of one or more sequentially connected bent passages 1223. The inflection point refers to a point where each bent passage 1223 turns, including outer inflection points and inner inflection points. For example, in the embodiment shown in FIG. 1, the inflection points include an outer inflection point located at the leftmost side of the bent passage 1223, and an inner inflection point at a position corresponding to the outer inflection point (i.e., the rightmost point on the bent passage 1223 in FIG. 1 positioned opposite the outer inflection point). In this embodiment, within a preset height range where the curved passage 122 is provided on the inner side wall of the cup body 100, the distance between any point on the inner side wall and the rotation axis is the second distance. All second distances are smaller than the first distance between the inflection point of the bent passage 1223 and the rotation axis, such that the bent passage 1223 can always be located on the side of the entire first opening 1221 away from the rotation axis (for example, FIG. 1 includes only one bent passage 1223, which is located on the side of the first opening 1221 away from the rotation axis).

Further, the bent passage 1223 includes, but is not limited to, a U-shaped bent passage or a J-shaped bent passage. In the cell centrifuge shown in FIG. 1, only one bent passage 1223 is provided. When the second opening 1222 is located near the inflection point, the bent passage 1223 is a J-shaped bent passage. When the second opening 1222 is located at a position substantially flush with the first opening 1221 (i.e., the inner side wall of the cup body 100), the bent passage 1223 is a U-shaped bent passage.

In this embodiment, an end of the delivery passage 121 away from the curved passage 122 communicates with the outside, so that fluids (for example: cell liquid, separation liquid, or gas) can be input to or output from the centrifugation space 110 of the cup body 100 through the delivery passage 121 and the curved passage 122. The inner side wall of the cup body 100 refers to a wall surface of the side wall of the cup body 100 near the rotation axis, which is also the inner wall of the centrifugation space 110. During centrifugation, the cup body 100 of the cell centrifuge is in a state of rotating about the rotation axis. Therefore, the target cells in the centrifugation space 110 (target cells are generally relatively heavy) are attached to the inner side wall of the cup body 100 under centrifugal force. The bent passage 1223 is located outside the inner side wall of the cup body 100. That is, the bent passage 1223 is bent in a direction away from the inner side wall of the cup body 100 and is located between the inner side wall and an outer side wall of the cup body 100. The first opening 1221 is located on the inner side wall. As shown in FIG. 1, the curved passage 122 includes only one bent passage 1223, and the single bent passage 1223 communicates with the first opening 1221. Thus, when liquid in the centrifugation space 110 is extracted through the first passage 120, the liquid will enter the bent passage 1223 from the first opening 1221. Since the bent passage 1223 is bent away from the inner side wall of the cup body 100, the flow direction of the fluid entering the bent passage 1223 from the first opening 1221 will be from the inner side wall toward the outer side wall of the cup body 100 (substantially no or very little upward thrust is generated). Therefore, throughout the process of extracting liquid through the first passage 120, because the target cells have been compressed and attached to the inner side wall of the cup body 100 under centrifugal force and there is substantially no upward thrust, extracting liquid through the first passage 120 will minimize the simultaneous extraction of the target cells to the greatest extent.

Meanwhile, when extracting the liquid in the centrifugation space 110 through the first passage 120, since the cup body 100 of the cell centrifuge is rotating about the rotation axis, liquids in the centrifugation space 110 other than the target cells will also be attached to the inner side wall of the cup body 100 under centrifugal force. Therefore, providing the first opening 1221 on the inner side wall of the cup body 100 can maximize the extraction of liquids other than the target cells that are not attached to the inner side wall of the cup body 100, minimizing liquid residue. Compared to a top passage scheme where the passage opening is provided at the top, when extracting liquid from the centrifugation space through a top passage, more residue will inevitably exist at the end of extraction. (When extracting to a position close to the inner side wall of the cup body, a portion of the liquid inevitably cannot be extracted due to the presence of gas in the passage, or gas is extracted along with the liquid).

In one embodiment, the first opening 1221 is provided at an upper portion of the inner side wall of the cup body 100. It can be understood that the delivery passage 121 is provided at the top of the cup body 100 and the curved passage 122 communicates with the delivery passage 121 through the second opening 1222. Therefore, providing the first opening 1221 of the curved passage 122 at the upper portion of the inner side wall of the cup body 100 can maintain a relatively short length of the curved passage 122, thereby reducing liquid residue in the curved passage 122 and lowering the manufacturing cost of the curved passage 122. Furthermore, providing the first opening 1221 at the upper portion of the inner side wall of the cup body 100 can avoid situations where some target cells slide down under their own gravity, causing more target cells to flow into the first opening 1221.

The cell centrifuge provided by the present application includes the curved passage 122 provided on the side wall of the cup body 100. The first opening 1221 of the curved passage 122 is provided on the inner side wall of the cup body 100, and the bent passage 1223 of the curved passage 122 is located outside the inner side wall of the cup body 100. Through the design of the curved passage 122 and the delivery passage 121 on the cup body 100, the present application can maximize the extraction of other liquids except for the target cells attached to the inner side wall of the cup body 100 while avoiding the extraction of the target cells as much as possible, thereby minimizing liquid residue, reducing the minimum concentrated volume, lowering costs, and improving cell centrifugation efficiency.

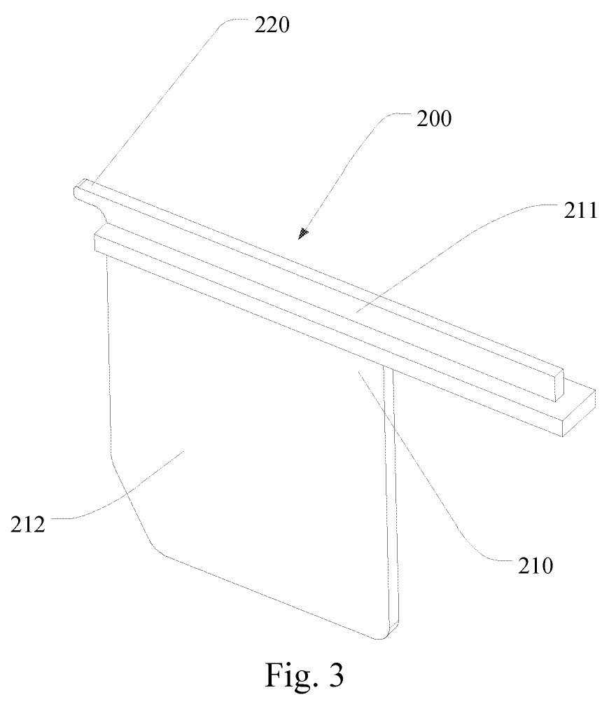

As shown in FIGS. 1 and 3, in some embodiments, the cell centrifuge further includes a liquid pushing plate 200 mounted on the cup body 100 and located within the centrifugation space 110. When the cup body 100 rotates about the rotation axis, the liquid pushing plate 200 rotates synchronously with the cup body 100, thereby pushing a liquid to rotate synchronously in the same direction as the cup body 100. Understandably, when the cup body 100 rotates, the liquid pushing plate 200 rotates synchronously with the cup body 100, reducing the relative motion between the outer layer liquid near the inner side wall of the cup body 100 and the inner layer liquid near the rotation axis. The driving source for the rotation of the inner layer liquid is no longer the viscous resistance between the outer layer liquid and the inner layer liquid, but the thrust of the liquid pushing plate 200. This avoids the shear effect of viscous resistance on the target cells in the liquid, thereby preventing shear damage to the target cells during centrifugation. Understandably, the specific number of liquid pushing plates 200 can be 1, 2, 3, or 4, and is not specifically limited here.

As shown in FIGS. 1 to 3, in some embodiments, a delivery slot 140 is provided at the top of the cup body 100, and a winding slot 150 communicating with the delivery slot 140 is provided on the side wall of the cup body 100. The liquid pushing plate 200 includes a pushing body 210 and a flow guiding portion 220 connected to a side of the pushing body 210 away from the rotation axis. A top end of the pushing body 210 is inserted into the delivery slot 140 and collectively defines the delivery passage 121 with a slot wall of the delivery slot 140. A bottom end of the pushing body 210 is connected to the bottom surface of the cup body 100. The flow guiding portion 220 is inserted into the winding slot 150 and collectively defines the curved passage 122 with the winding slot 150. Understandably, the delivery passage 121 can be formed by direct machining on the top of the cup body 100 or by enclosing multiple components. The curved passage 122 can be formed by direct machining on the side wall of the cup body 100 or by enclosing multiple components. In this embodiment, to reduce manufacturing difficulty, the delivery passage 121 is formed by the top end of the pushing body 210 being inserted into the delivery slot 140 and collectively defined with the slot wall of the delivery slot 140. The curved passage 122 is formed by the flow guiding portion 220 being inserted into the winding slot 150 and collectively defined with the winding slot 150. In this way, the liquid pushing plate 200 is fully utilized, reducing the number of components while lowering manufacturing difficulty. Further, when the flow guiding portion 220 is inserted into the winding slot 150, an end of the flow guiding portion 220 away from the rotation axis is located outside the inner side wall of the cup body 100, allowing the first opening 1221 to be located on the inner side wall of the cup body 100.

As shown in FIGS. 1 to 3, in some embodiments, the pushing body 210 includes a connecting portion 211 inserted into the delivery slot 140 and collectively defining the delivery passage 121 with the slot wall of the delivery slot 140, and a pushing portion 212 connected below the connecting portion 211. An end of the pushing portion 212 away from the connecting portion 211 is connected to the bottom surface of the cup body 100. The flow guiding portion 220 is connected to the connecting portion 211. A liquid passage gap communicating with the first opening 1221 is provided between the pushing portion 212 and the inner side wall of the cup body 100. A side of the pushing portion 212 away from the liquid passage gap is spaced from the rotation axis by a preset distance, the preset distance being greater than the liquid passage gap.

In this embodiment, during the centrifugation process of the cup body 100, target cells in the sample liquid gradually move toward the inner side wall of the cup body 100, pass through the liquid passage gap, and finally attach to the inner side wall of the cup body 100, thereby preventing the target cells from accumulating on the liquid pushing plate 200. In addition, the sample liquid can freely pass through the liquid passage gap, ensuring that the liquid level heights on both sides of the liquid pushing plate 200 remain consistent. Providing the preset distance between the liquid pushing plate 200 and the rotation axis serves to provide a certain operation space for the installation and disassembly of the liquid pushing plate 200. Understandably, the liquid passage gap should not be set too large; if the liquid passage gap is too large, the liquid pushing plate 200 cannot provide a good liquid pushing effect. Meanwhile, the sample liquid near the rotation axis has a lower linear velocity during the centrifugation process, so providing the interval of the preset distance has little impact on the centrifugation effect of the sample liquid (while needing to provide a larger operation space). Therefore, the preset distance needs to be greater than the liquid passage gap.

As shown in FIG. 1, in some embodiments, the cup body 100 also includes a second passage 160 provided at the bottom of the cup body 100 and communicating with the centrifugation space 110.

In this embodiment, providing the second passage 160 at the bottom of the cup body 100 to communicate with the centrifugation space 110 allows liquid (such as sample liquid or separation liquid) to enter the centrifugation space 110 from the bottom of the cup body 100 through the second passage 160. This prevents the liquid from splashing when added to the centrifugation space 110 through the first passage 120, ensuring stability during the process of adding liquid to the centrifugation space 110. Furthermore, after a mixed liquid is obtained following the completion of centrifugation, the mixed liquid can collect at the second passage 160 at the bottom of the cup body 100 under the action of gravity, making it easier to extract through the second passage 160 and reducing mixed liquid residue.

As shown in FIG. 1, in some embodiments, the inner side wall of the cup body 100 includes a straight wall segment 171 and a slope segment 172 connected below the straight wall segment 171. The first opening 1221 is provided on the straight wall segment 171. An end of the slope segment 172 away from the straight wall segment 171 is connected to the bottom wall of the cup body 100. Along a direction from top to bottom of the rotation axis, a vertical distance between the slope segment 172 and the rotation axis gradually decreases. Understandably, after the liquid other than the target cells is extracted through the first passage 120, the residual liquid (including target cells) will remain at a chamfered position corresponding to the slope segment 172 below the centrifugation space 110 after being mixed, which facilitates maximizing its extraction from the second passage 160. Meanwhile, during the process of extracting the liquid other than the target cells through the first passage 120, the liquid in the centrifugation space 110 other than the target cells can also overcome the influence of gravity under centrifugal force, with the acceleration direction toward the inner side wall of the cup body 100. Therefore, the liquid in the slope segment 172 will collect toward the straight wall segment 171 under centrifugal force. Accordingly, providing the first opening 1221 on the straight wall segment 171 allows for the maximum extraction of the liquid other than the target cells that is not attached to the inner side wall of the cup body 100, minimizing liquid residue to the greatest extent.

As shown in FIG. 1, in some embodiments, the second passage 160 includes a third opening 161 provided on the bottom wall of the cup body 100. The second passage 160 communicates with the centrifugation space 110 through the third opening 161, and the end of the slope segment 172 away from the straight wall segment 171 is provided at an opening edge of the third opening 161. Understandably, the third opening 161 can be provided at a preset position of the bottom wall of the cup body 100 as needed. In this embodiment, the end of the slope segment 172 away from the straight wall segment 171 is provided at the opening edge of the third opening 161. That is, the third opening 161 is at the edge of the bottom wall of the cup body 100, so that when extracting liquid through the second passage 160, the liquid can be better guided by the slope segment 172 to the position of the third opening 161, further reducing liquid residue.

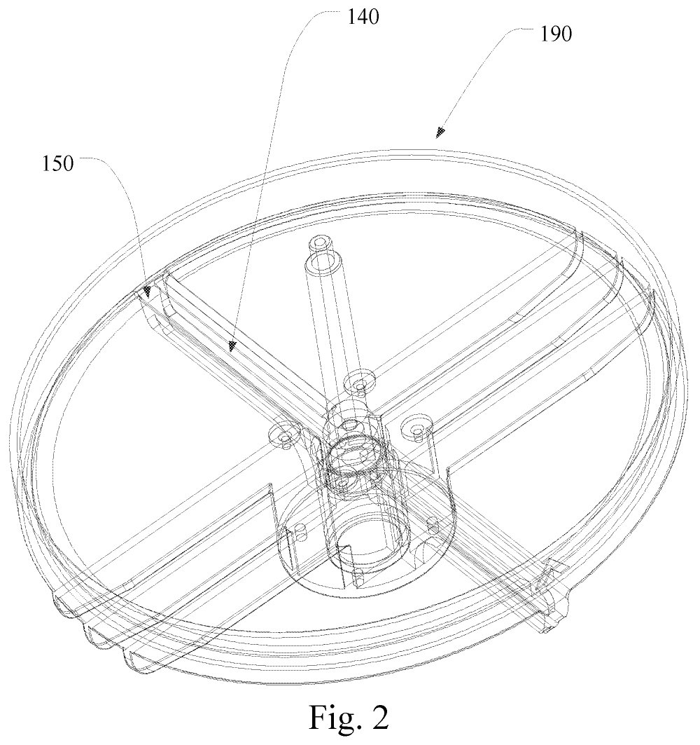

As shown in FIGS. 1 and 2, in some embodiments, the cup body 100 includes a cup body shell 180 having an opening at its top, and a cup cap 190 detachably (the detachable manner including but not limited to a snap-fit connection, etc.) covered on the opening. The cup cap 190 is provided with a first access passage 191 and a second access passage 192. (Understandably, the specific structural designs of the first access passage 191 and the second access passage 192 are not limited to those shown in FIG. 1, but the flow channels can be specifically designed according to requirements. For example, different control valves can be designed on the first access passage 191 and the second access passage 192 to control the on-off state of the flow channels. Pistons or the like can be provided at positions where the first access passage 191 and the second access passage 192 connect with the cup body 100 or other components to cooperate in sealing or flow channel direction changes, which will not be further detailed here). The first access passage 191 communicates with an end of the delivery passage 121 away from the curved passage. The second access passage 192 communicates with an end of the second passage 160 away from the centrifugation space 110. The curved passage is provided on the cup cap 190 and/or the cup body shell 180. Understandably, an end of the first access passage 191 away from the delivery passage 121 communicates with the outside, and an end of the second access passage 192 away from the second passage 160 communicates with the outside, so that fluids (such as cell liquid, separation liquid, or gas) can be injected into the centrifugation space 110 of the cup body 100 through the first access passage 191 and/or the second access passage 192. Understandably, the cup body 100 of the cell centrifuge is in a state of rotating about the rotation axis during centrifugation. Therefore, the delivery passage 121 generally communicates with the first access passage 191 at the rotation axis (where no displacement occurs when the cup body 100 rotates) via a connection such as a rotating seal. The second passage 160 generally communicates with the second access passage 192 at the rotation axis (where no displacement occurs when the cup body 100 rotates) via a connection such as a rotating seal. This keeps the first access passage 191 and the second access passage 192 relatively stationary while the cup body 100 rotates, facilitating communication with external pipelines. The curved passage can be provided independently on the cup body shell 180, or independently on the cup cap 190, or on both the cup cap 190 and the cup body shell 180. The inner side wall of the cup body 100 can include the inner side wall of the cup cap 190 and/or the inner side wall of the cup body shell 180. The curved passage is formed through the connection of the cup cap 190 and the cup body shell 180.

Further, the cup cap 190 is provided with vent holes (not shown) communicating with the centrifugation space. At least one vent hole is provided, and a breathable membrane is arranged within the vent hole. Specifically, when the cell centrifuge is used for cell culture, the breathable membrane can prevent external bacteria from entering the centrifugation space. Meanwhile, the breathable membrane enables gas exchange between the centrifugation space and the outside, ensuring normal respiration of the cells within the centrifugation space. Further, the breathable membrane is preferably a hydrophobic breathable membrane.

In one embodiment, a recess 130 is provided on the inner side wall of the cup body 100, and the first opening 1221 is provided on an inner wall of the recess 130. Understandably, target cells (generally relatively heavy) in the centrifugation space 110 are attached to the inner side wall of the cup body 100 under centrifugal force. After the liquid in the centrifugation space 110 is extracted to the inner side wall of the cup body 100, part of the liquid may adhere to the inner side wall due to the viscosity of the liquid. By providing the recess 130 on the inner side wall of the cup body 100, i.e., providing the recess 130 along the direction of centrifugal force, when the liquid in the centrifugation space 110 is extracted to the inner side wall, the liquid adhering to the inner side wall will continue to accumulate in the recess 130. Since the first opening 1221 is provided on the inner wall of the recess 130, more of the liquid accumulated in the recess 130 can be extracted through the first opening 1221, thereby further reducing the minimum concentrated volume. Further, the first opening 1221 is provided at an end of the inner wall of the recess 130 away from the rotation axis, allowing for maximum extraction of the liquid in the centrifugation space 110. The recess 130 can be configured according to actual conditions, such as a rectangular recess (gradient structure), a conical recess (continuous structure), or a spherical recess. The recess 130 can be provided on the cup cap or/and the cup body shell of the cup body.

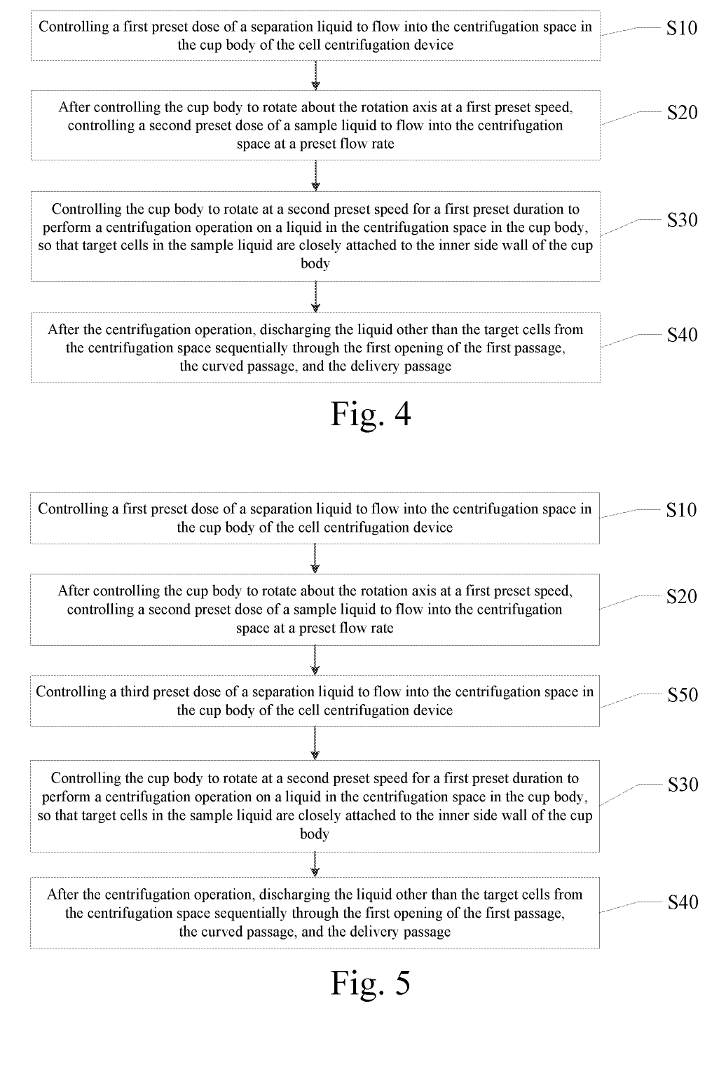

As shown in FIG. 4, an embodiment of the present application also provides a cell centrifugation method executed by the cell centrifuge. The cell centrifugation method includes:

S10: Controlling a first preset dose of a separation liquid to flow into the centrifugation space 110 in the cup body 100 of the cell centrifuge. In one embodiment, by controlling the rotation of a peristaltic pump (which can be clockwise or counter-clockwise, or other liquid pumps), the separation liquid flows into the centrifugation space 110. This allows precise control of the first preset dose of the separation liquid flowing into the centrifugation space 110 in the cup body 100. The first preset dose of the separation liquid can flow into the centrifugation space 110 through the first passage 120 (or the second passage 160). The first preset dose can be set according to actual conditions, provided that it serves as a buffer when the sample liquid enters the centrifugation space 110, for example, by considering the pipeline length or the capacity of the centrifugation space 110. In one embodiment, the first preset dose is 120 mL–150 mL, ensuring that after the separation liquid enters the centrifugation space 110 through the pipeline, it buffers the sample liquid entering the centrifugation space 110 in step S20. Understandably, in step S10, the cell centrifuge can also inject the separation liquid after starting the rotation of the cup body 100 (a specific speed can be set according to requirements, such as setting it to be the same as the first preset speed; in this case, the cup body can maintain rotation at the first preset speed in step S20 without needing to be started again).

S20: After controlling the cup body 100 to rotate about the rotation axis at a first preset speed, controlling a second preset dose of a sample liquid to flow into the centrifugation space 110 at a preset flow rate. Understandably, controlling the cup body 100 to rotate about the rotation axis at the first preset speed refers to controlling the cup body 100 to start the centrifugation operation. Understandably, controlling the cup body 100 to rotate about the rotation axis at the first preset speed can occur before step S10. That is, the cup body 100 is controlled to rotate about the rotation axis at the first preset speed, and then the first preset dose of the separation liquid is controlled to flow into the centrifugation space 110. Controlling the cup body 100 to rotate about the rotation axis at the first preset speed can also occur after step S10 or simultaneously with step S10 to save processing time. The preset flow rate range can be set to 0–300 mL/min, and the preset flow rate can be achieved by squeezing a pipeline through the rotation of a non-contact peristaltic pump. In this embodiment, the cup body 100 is first controlled to rotate about the rotation axis at the first preset speed, and then the second preset dose of the sample liquid is controlled to flow into the centrifugation space 110. This allows the sample liquid to be centrifuged as soon as it enters the centrifugation space 110, saving processing time and improving efficiency. The first preset speed can be set according to actual conditions to achieve the best centrifugation effect according to different types of sample liquids. In one embodiment, the first preset speed is in a range of 2000 rpm–2500 rpm (revolutions per minute) to achieve the best centrifugation effect for a sample liquid containing PBMC cells (peripheral blood mononuclear cells, which are the target cells). The second preset dose can be set according to actual conditions, generally considering factors such as the capacity of the sample liquid bag or the size of the centrifugation space 110. In one embodiment, the second preset dose is 150 mL–200 mL.

S30: Controlling the cup body 100 to rotate at a second preset speed for a first preset duration to perform a centrifugation operation on a liquid in the centrifugation space 110 in the cup body 100, so that target cells in the sample liquid are closely attached to the inner side wall of the cup body 100. Understandably, after the first preset dose of the separation liquid and the second preset dose of the sample liquid are injected into the centrifugation space 110, continuous centrifugation of the liquid in the centrifugation space 110 can begin. The first preset duration can be set according to actual conditions to achieve the best centrifugation effect according to different types or doses of sample liquids. In one embodiment, the first preset duration is 150 seconds, achieving the best centrifugation effect for a sample liquid that is preferably 150 mL. The second preset speed can be set according to actual conditions (the second preset speed can be the same as or different from the first preset speed) to achieve the best centrifugation effect according to different types of sample liquids. In one embodiment, the second preset speed is preferably 2000 rpm to achieve the best centrifugation effect for a sample liquid containing PBMC cells (target cells).

S40: Discharging the liquid other than the target cells after the centrifugation operation from the centrifugation space 110 sequentially through the first opening 1221 of the first passage 120, the curved passage 122, and the delivery passage 121. Understandably, as the cup body 100 continues to rotate, the target cells in the sample liquid (generally relatively heavy, such as PBMC cells) are closely attached to the inner side wall of the cup body 100. The bent passage 1223 is located outside the inner side wall of the cup body 100, meaning the bent passage 1223 is bent in a direction away from the inner side wall and is located between the inner side wall and the outer side wall of the cup body 100. The first opening 1221 is located on the inner side wall. When liquid in the centrifugation space 110 is extracted through the first passage 120, the liquid will enter the bent passage 1223 from the first opening 1221. Since the bent passage 1223 is bent away from the inner side wall of the cup body 100, the flow direction of the fluid entering the bent passage 1223 from the first opening 1221 is from the inner side wall toward the outer side wall (generating substantially no or very little upward thrust). Therefore, throughout the process of extracting liquid through the first passage 120, because the target cells have been compressed and attached to the inner side wall under centrifugal force and there is substantially no upward thrust, extracting liquid through the first passage 120 minimizes simultaneous extraction of the target cells. Meanwhile, when extracting liquid through the first passage 120, because the cup body 100 is rotating, the liquid other than the target cells will also be attached to the inner side wall under centrifugal force. Therefore, providing the first opening 1221 on the inner side wall allows for maximum extraction of liquids other than the target cells that are not attached to the inner side wall, minimizing liquid residue.

Therefore, in the above embodiments of the present application, through the design of the curved passage 122 and the delivery passage 121 on the cup body 100, extraction of other liquids except for target cells attached to the inner side wall can be maximized while avoiding target cell extraction as much as possible. This minimizes liquid residue, reduces the minimum concentrated volume, lowers costs, and improves cell centrifugation efficiency.

As shown in FIG. 5, in some embodiments, in step S20, after the controlling a second preset dose of a sample liquid to flow into the centrifugation space 110 at a preset flow rate, the method further includes:

S50: Controlling a third preset dose of a separation liquid to flow into the centrifugation space 110. Understandably, in step S20, some sample liquid will remain in the pipeline before entering the centrifugation space 110. To avoid waste of the sample liquid, in this embodiment, by controlling the third preset dose of the separation liquid to flow into the centrifugation space 110, the sample liquid remaining in the pipeline can be pushed into the centrifugation space 110. The third preset dose is set according to actual conditions, as long as all the sample liquid remaining in the pipeline is pushed into the centrifugation space 110. In one embodiment, the third preset dose is 30 mL–40 mL.

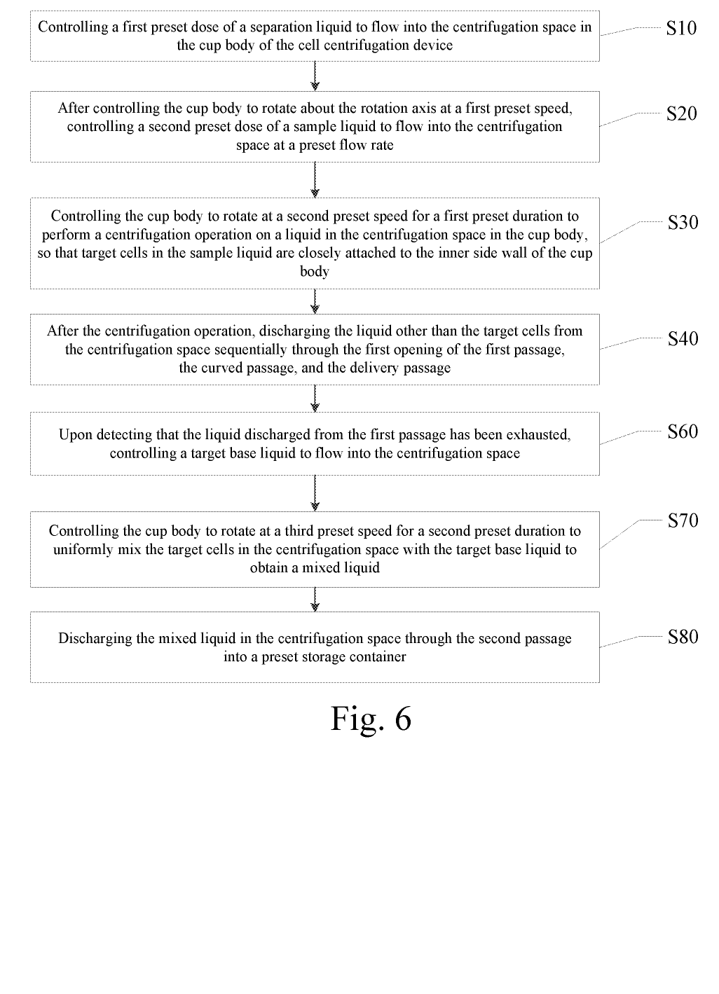

As shown in FIG. 6, in some embodiments, the cup body 100 also includes a second passage 160 provided at the bottom of the cup body 100 and communicating with the centrifugation space 110. After step S40, in which the liquid other than the target cells after the centrifugation operation is discharged from the centrifugation space 110 sequentially through the first opening 1221, the curved passage 122, and the delivery passage 121, the method further includes:

S60: Upon detecting that the liquid discharged from the first passage 120 has been exhausted, controlling a target base liquid to flow into the centrifugation space 110. The target base liquid includes at least one of a cleaning liquid, a cryopreservation liquid, or a culture medium liquid.

S70: Controlling the cup body 100 to rotate at a third preset speed for a second preset duration to uniformly mix the target cells in the centrifugation space 110 with the target base liquid to obtain a mixed liquid. Understandably, the third preset speed can be set according to actual conditions to achieve the best mixing effect for different types of sample liquids. In one embodiment, the third preset speed is 2000 rpm, which can achieve the best mixing effect for a sample liquid containing PBMC cells. The second preset duration can be set according to actual conditions to achieve the best mixing effect for different types of sample liquids. In one embodiment, the second preset duration is 210 seconds, which can achieve the best mixing effect for a sample liquid containing PBMC cells.

S80: Discharging the mixed liquid in the centrifugation space 110 through the second passage 160 into a preset storage container. Understandably, in this step, the cup body 100 stops rotating, and the mixed liquid in the centrifugation space 110 falls to the bottom of the cup body 100 under the action of gravity. Since the second passage 160 is provided at the bottom of the cup body 100, the mixed liquid can be extracted from the bottom of the cup body 100 to the greatest extent, preventing mixed liquid residue and avoiding cost waste.

Understandably, the above cell centrifugation method is not limited to the descriptions in the above embodiments. The specific settings of the cell centrifugation method of the present application correspond one-to-one with those of the above cell centrifuge and will not be detailed again here.

An embodiment of the present application also provides a controller. The controller includes a processor and a memory. The memory stores an executable program. The processor is used to execute the executable program to implement the cell centrifugation method.

The specific settings of the controller of the present application correspond one-to-one with the above cell centrifugation method and will not be detailed again here. Each module in the above controller can be fully or partially implemented through software, hardware, or a combination thereof. These modules can be embedded in or independent of the controller in hardware form, or stored in the controller in software form to facilitate the controller in calling and executing operations corresponding to the above modules.

An embodiment of the present application also provides one or more computer-readable storage media storing a computer-readable instruction. When the computer-readable instruction is executed by one or more processors, the one or more processors implement the above cell centrifugation method.

A person of ordinary skill in the art can understand that all or part of the processes in the methods of the above embodiments can be completed by computer-readable instructions instructing relevant hardware. The computer-readable instructions can be stored in a non-volatile readable storage medium or a volatile readable storage medium. When executed, the computer-readable instructions can include the processes in the embodiments of the methods described above. Any references used in the embodiments provided by this application to memory, storage, a database, or other media can include non-volatile and/or volatile memory. Non-volatile memory can include Read-Only Memory (ROM), Programmable ROM (PROM), Erasable Programmable ROM (EPROM), Electrically Erasable Programmable ROM (EEPROM), or flash memory. Volatile memory can include Random Access Memory (RAM) or external cache memory. As an illustration and not a limitation, RAM is available in various forms, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), Rambus Direct RAM (RDRAM), Direct Rambus Dynamic RAM (DRDRAM), and Rambus Dynamic RAM (RDRAM).

Those skilled in the art can clearly understand that, for convenience and brevity of description, only the division of the functional units and modules above is used as an example. In practical applications, the above function allocations can be completed by different functional units or modules as needed. That is, the internal structure of the system is divided into different functional units or modules to complete all or part of the functions described above.

The above are only embodiments of the cell centrifuge, method, controller, and medium of this application and are not intended to limit this application. Any modifications, equivalent replacements, and improvements made within the spirit and principle of this application shall be included within the protection scope of this application.

1. A cell centrifuge, comprising a cup body provided with a centrifugation space and a first passage; the cup body having a rotation axis, and the cup body being rotatable about the rotation axis;
wherein the first passage comprises a delivery passage provided at a top of the cup body, and a curved passage provided on a side wall of the cup body; two ends of the curved passage are respectively provided with a first opening and a second opening; the first opening is provided on an inner side wall of the cup body; the curved passage communicates with the centrifugation space through the first opening, and the curved passage communicates with the delivery passage through the second opening; and the curved passage further comprises at least one bent passage located outside the inner side wall of the cup body.

2. The cell centrifuge of claim 1, wherein a first distance between an inflection point of the bent passage and the rotation axis is greater than a second distance between the inner side wall of the cup body and the rotation axis.

3. The cell centrifuge of claim 1, wherein the bent passage comprises a U-shaped bent passage or a J-shaped bent passage.

4. The cell centrifuge of claim 1, wherein the cell centrifuge further comprises a liquid pushing plate mounted on the cup body and located within the centrifugation space;
when the cup body rotates about the rotation axis, the liquid pushing plate rotates synchronously with the cup body, thereby pushing a liquid to rotate synchronously in the same direction as the cup body.

5. The cell centrifuge of claim 4, wherein a delivery slot is provided at the top of the cup body, and a winding slot communicating with the delivery slot is provided on the side wall of the cup body;
the liquid pushing plate comprises a pushing body and a flow guiding portion connected to a side of the pushing body away from the rotation axis; a top end of the pushing body is inserted into the delivery slot, collectively defining the delivery passage with a slot wall of the delivery slot; a bottom end of the pushing body is connected to a bottom surface of the cup body; the flow guiding portion is inserted into the winding slot, collectively defining the curved passage with the winding slot.

6. The cell centrifuge of claim 5, wherein the pushing body comprises a connecting portion inserted into the delivery slot and collectively defining the delivery passage with the slot wall of the delivery slot, and a pushing portion connected below the connecting portion, an end of the pushing portion away from the connecting portion being connected to the bottom surface of the cup body; the flow guiding portion is connected to the connecting portion;
a liquid passage gap communicating with the first opening is provided between the pushing portion and the inner side wall of the cup body; and a side of the pushing portion away from the liquid passage gap is spaced from the rotation axis by a preset distance, the preset distance being greater than the liquid passage gap.

7. The cell centrifuge of claim 1, wherein the cup body further comprises a second passage, the second passage being provided at a bottom of the cup body and communicating with the centrifugation space.

8. The cell centrifuge of claim 7, wherein the inner side wall of the cup body comprises a straight wall segment and a slope segment connected below the straight wall segment, the first opening being provided on the straight wall segment; an end of the slope segment away from the straight wall segment is connected to a bottom wall of the cup body;
along a direction from top to bottom of the rotation axis, a vertical distance between the slope segment and the rotation axis gradually decreases.

9. The cell centrifuge of claim 8, wherein the second passage comprises a third opening provided on the bottom wall of the cup body; the second passage communicates with the centrifugation space through the third opening, and the end of the slope segment away from the straight wall segment is provided at an opening edge of the third opening.

10. The cell centrifuge of claim 7, wherein the cup body comprises a cup body shell having an opening at a top thereof, and a cup cap detachably covered on the opening; the cup cap is provided with a first access passage and a second access passage; the first access passage communicates with an end of the delivery passage away from the curved passage; the second access passage communicates with an end of the second passage away from the centrifugation space; and the curved passage is provided on the cup cap and/or the cup body shell.

11. The cell centrifuge of claim 1, wherein a recess is provided on the inner side wall of the cup body, and the first opening is provided on an inner wall of the recess.

12. A cell centrifugation method, wherein the cell centrifugation method is executed by the cell centrifuge of claim 1, the cell centrifugation method comprising:
controlling a first preset dose of a separation liquid to flow into the centrifugation space in the cup body of the cell centrifuge;
after controlling the cup body to rotate about the rotation axis at a first preset speed, controlling a second preset dose of a sample liquid to flow into the centrifugation space at a preset flow rate;
controlling the cup body to rotate at a second preset speed for a first preset duration to perform a centrifugation operation on a liquid in the centrifugation space in the cup body, so that target cells in the sample liquid are closely attached to the inner side wall of the cup body; and
after the centrifugation operation, discharging the liquid other than the target cells from the centrifugation space sequentially through the first opening of the first passage, the curved passage, and the delivery passage.

13. The cell centrifugation method of claim 12, wherein after the controlling a second preset dose of a sample liquid to flow into the centrifugation space at a preset flow rate, the method further comprises:
controlling a third preset dose of the separation liquid to flow into the centrifugation space.

14. The cell centrifugation method of claim 12, wherein the cup body further comprises the second passage, the second passage being provided at the bottom of the cup body and communicating with the centrifugation space;
after the discharging the liquid other than the target cells from the centrifugation space sequentially through the first opening, the curved passage, and the delivery passage, the method further comprises:
upon detecting that the liquid discharged from the first passage has been exhausted, controlling a target base liquid to flow into the centrifugation space;
controlling the cup body to rotate at a third preset speed for a second preset duration to uniformly mix the target cells in the centrifugation space with the target base liquid to obtain a mixed liquid; and
discharging the mixed liquid in the centrifugation space through the second passage into a preset storage container.

15. A controller, comprising a processor and a memory, the memory stores an executable program, and the processor is configured to execute the executable program to implement the cell centrifugation method of claim 12.

16. One or more computer-readable storage media storing a computer-readable instruction, wherein when the computer-readable instruction is executed by one or more processors, the one or more processors implement the cell centrifugation method of claim 12.

17. A controller, comprising a processor and a memory, the memory stores an executable program, and the processor is configured to execute the executable program to implement the cell centrifugation method of claim 13.

18. A controller, comprising a processor and a memory, the memory stores an executable program, and the processor is configured to execute the executable program to implement the cell centrifugation method of claim 14.

19. One or more computer-readable storage media storing a computer-readable instruction, wherein when the computer-readable instruction is executed by one or more processors, the one or more processors implement the cell centrifugation method of claim 13.

20. One or more computer-readable storage media storing a computer-readable instruction, wherein when the computer-readable instruction is executed by one or more processors, the one or more processors implement the cell centrifugation method of claim 14.
